(19) United States
(12) Patent Application Publication
(10) Pub. No.: US 2008/0148327 A1
(43) Pub. Date: Jun. 19, 2008

(54) Method and Apparatus for Providing Adaptive Trick Play Control of Streaming Digital Video

(75) Inventor: Yanbing Xu, Nashua, NH (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/612,048

(22) Filed: Dec. 18, 2006

(51) Int. Cl. H04N 7/173

(52) U.S. Cl. 725/105

(57) ABSTRACT

A method and system for providing adaptive trick play control of streaming digital video is disclosed. The method includes receiving a request to change a rate of transmission of data packets from a first rate of transmission to a requested second rate of transmission. The data packets are transmitted at a third rate of transmission. Next, a feedback is received pertaining to the third rate of transmission in the transmitting step. Subsequently, the third rate of transmission is adjusted to approximately equal the requested second rate of transmission in response to the feedback.

### FIELD OF THE INVENTION

The present invention relates generally to transmission and control of video data and, in particular, streaming digital video.

### BACKGROUND OF THE INVENTION

Streaming digital video is currently used in many applications today. With advancements in the development of the Internet and digital video compression technologies, data transmission speeds are increasing. Consequently streaming digital video is becoming more popular and a preferred method of providing digital video to end users. People expect to view digital video stored in remote servers just as if they are watching it from a local DVD player. Video streaming generally means that a server does not need to send a whole video file before a receiving player can start decoding the received frames.

Currently, users are able to watch streaming digital video at a normal playback speed. However, when watching streaming digital video at a trick play speed, a user does not have precise control of streaming digital video. Trick play, is the ability to fast forward, rewind or slow motion replay digital video at different speeds.

Present methods of providing trick play of streaming digital video have many drawbacks. For example, some methods provide trick play that is choppy and jerking due to many skipped frames. Some methods provide trick play that is not accurate. Finally, other methods provide trick play that consumes a large amount of bandwidth. Therefore, a need exists for a method and system to provide adaptive trick play control of streaming digital video that is smooth, accurate and consumes minimal bandwidth.

### SUMMARY OF THE INVENTION

In one embodiment, the present invention discloses a method and system for providing adaptive trick play control of streaming digital video. Since it is difficult for a user to accurately gauge whether streaming digital video is being provided to the user's video player at a requested trick play speed, the present method discloses an approach where feedback is provided by the user's video player to the video server that is streaming the digital video. Using the feedback, the video server is capable of adjusting the rate of transmission of frames to better match the requested trick play speed.

### BRIEF DESCRIPTION OF THE DRAWINGS

The teaching of the present invention can be readily understood by considering the following detailed description in conjunction with the accompanying drawings, in which:

FIG. 1 illustrates an exemplary architectural overview of the present invention;

FIG. 2 illustrates a detailed block diagram of an exemplary video server and a video player;

FIG. 3 illustrates an exemplary flow chart of a method for providing adaptive trick play control of streaming digital video;

FIG. 4 illustrates an exemplary flow chart of communications between the video server and the video player;

FIG. 5 illustrates an exemplary data structure of a data packet from the video server to the video player;

FIG. 6 illustrates an exemplary data structure of a data packet from the video player to the video server;

FIG. 7 illustrates a detailed flow chart of an exemplary method for providing adaptive trick play control of streaming digital video; and

FIG. 8 illustrates a high level block diagram of an exemplary general purpose computer suitable for use in performing the functions described herein.

To facilitate understanding, identical reference numerals have been used, where possible, to designate identical elements that are common to the figures.

### DETAILED DESCRIPTION

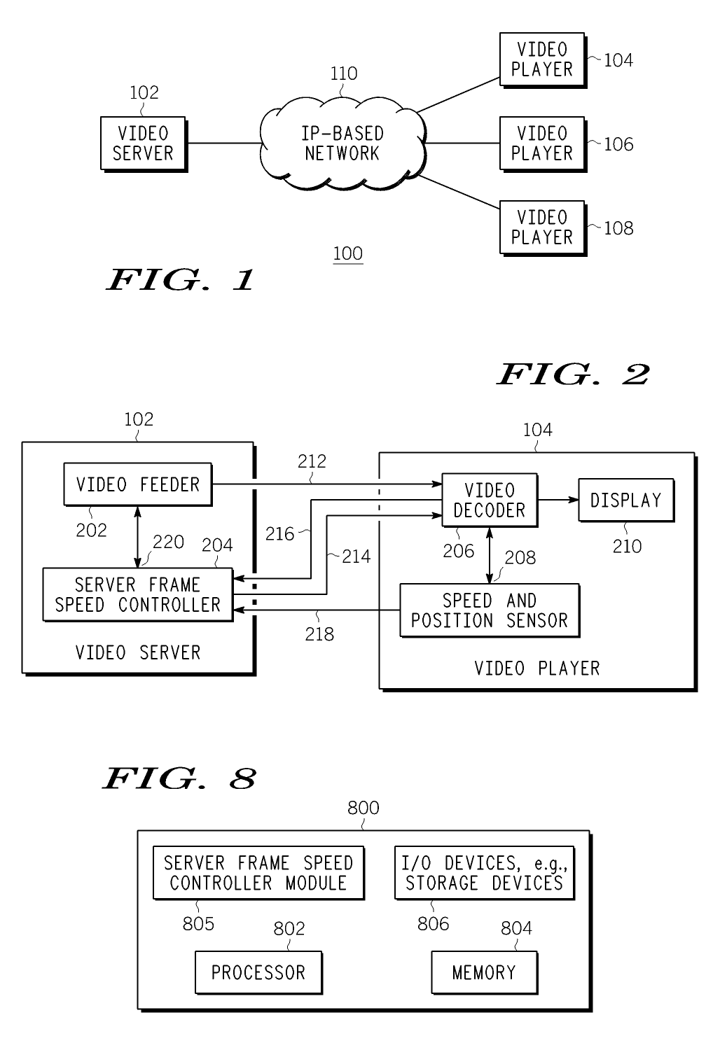

An exemplary architectural overview of a network 100 is illustrated in FIG. 1. In an exemplary embodiment, network 100 includes a video server 102 and a plurality of video players 104, 106 and 108. One skilled in the art will recognize that although one video server and three video players are shown in FIG. 1, any number of video servers and video players may be used in accordance with the present invention. Video players 104, 106 and 108 may be any device capable of receiving and displaying digital video, such as for example, a desktop computer, a laptop computer or a set top box, and the like. In one embodiment, video server 102 and video players 104, 106 and 108 communicate with each other via an internet protocol (IP) based network 110. IP based network 110 may be any internet protocol based network such as for example, the Internet, a Wide Area Network (WAN) or a Local Area Network (LAN). Network 100 may use any protocol for communication between the video server 102 and the video players 104, 106 and 108 such as, for example, Real-time Transport Protocol (RTP), RTP Control Protocol (RTCP) and Real Time Streaming Protocol (RTSP). It should be noted that the present invention is not limited by the type of network that the encoded frames are traversing over.

FIG. 2 illustrates a more detailed view of the interaction of the video server and one of the video players. FIG. 2 illustrates a detailed block diagram of the video server 102 and one of the video players 104. A single video player is illustrated only for purposes of clarity and should not be interpreted as limiting the invention to only a single video player. As discussed above, any number of video players may be used in accordance with the present invention. Furthermore, various network components of the IP based network 110 is not illustrated in FIG. 2 for purposes of clarity.

In an exemplary embodiment, video server 102 includes a video feeder 202 and a server frame speed controller 204. In an exemplary embodiment, video player 104 includes a video decoder 206, a speed and position sensor 208 and a display 210. Video server 102 and video player 104 may communicate over transmission lines 212, 214, 216 and 218 via the IP based network 110 (not shown). It should be noted that although four transmission lines are shown in FIG. 2, the present invention is not so limited. Namely, any number or physical/logical communication lines can be deployed to effect communications between the video server and the video player.

Video feeder 202 provides a requested streaming digital video to a requesting end user at video player 104. The requested streaming digital video may be transmitted, for example, by data packets comprising frames or fields. Each data packet may represent one or more frames or fields of the requested streaming digital video. The data packets can be transmitted to the video player 104 via transmission line 212.

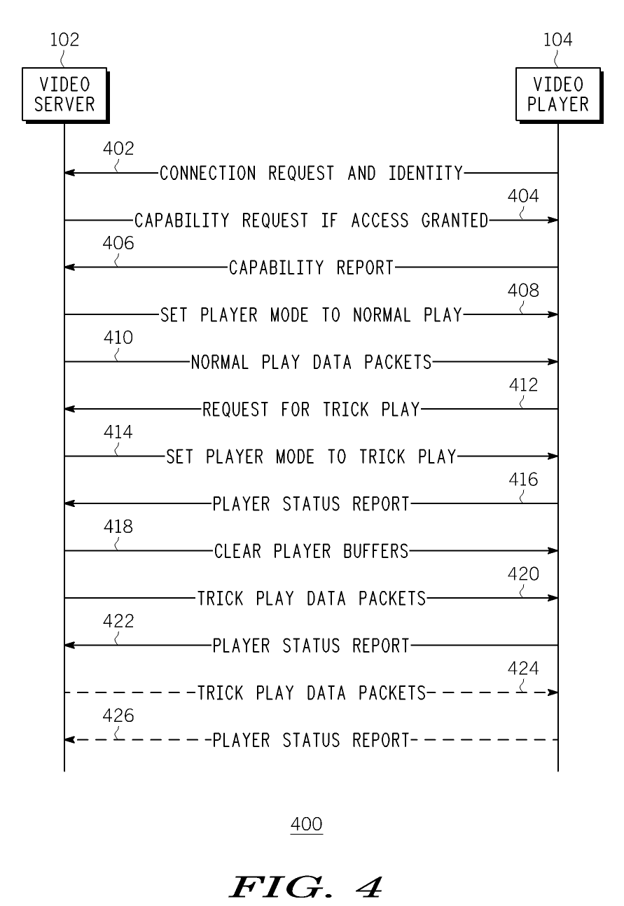

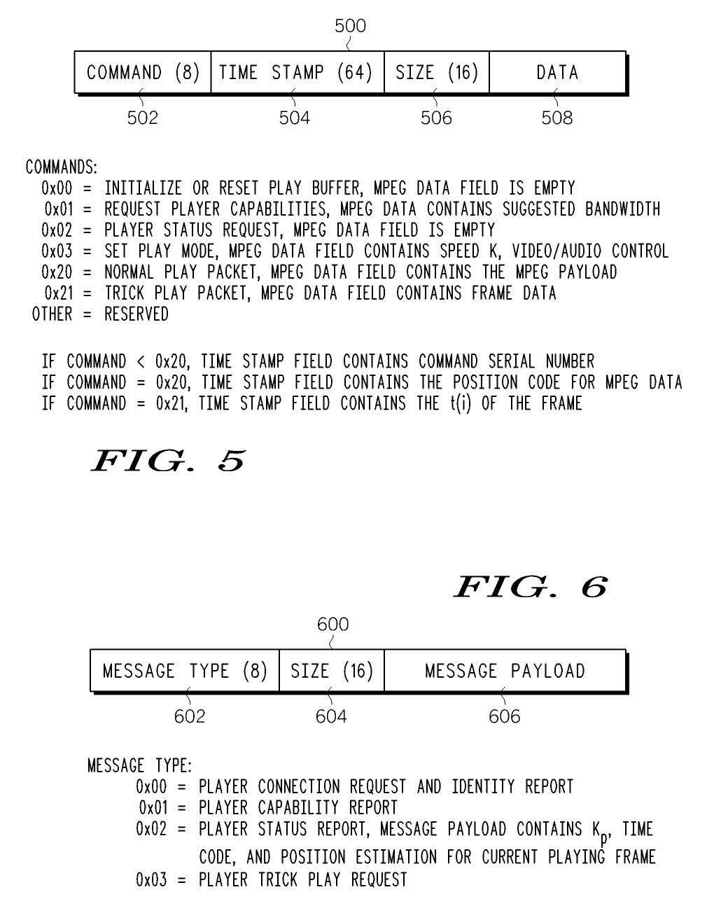

In one embodiment, server frame speed controller 204 provides the adaptive trick play control of the streaming digital video. Server frame speed controller 204 sends instructions (e.g., when to change from a normal play mode to a trick play mode and vice versa, as discussed below with reference to FIG. 4) via data packets (detailed below in FIG. 5) to the video player 104 via transmission line 214. For example, the server video may coordinate with the video player as to when track play mode will start and when to return to normal play mode. Server frame speed controller 204 sends instructions via transmission line 220 to adjust the rate of transmission of the frames or fields being sent by video feeder 202. Server frame speed controller instructs video feeder 202 based on feedback received from speed and position sensor 208 via transmission line 218. The rate of transmission of the frames or fields sent by video feeder 202 correlates to the play back speed of the streaming digital video perceived by the end user at video player 104. However, un-deterministic delay, complexity of the video data (e.g., a large amount of successive scene changes, or motion in the video data) and buffering of IP packets may hinder accurate determination of playback speed. In other words, the video server 102 may believe that its transmission rate is producing a particular playback speed, but in reality, the actual playback speed at the video player 104 can be quite different. As such, speed and position sensor 208 retrieves speed and position information of the frames or fields from video decoder 206 to assess the actual playback speed at the video player 104.

Video decoder 206 may receive the data packets (e.g., containing frames or fields of the video data) from video feeder 202 via transmission line 212. In turn, video decoder 206 provides the frames or fields to display 210 for showing the streaming digital video to the end user at video player 104. It should be noted that video player 104 also employs a small buffer (not shown) for temporarily storing the decoded frames or fields prior to sending them to be displayed in display 210. Video decoder 206 may, for example, communicate with server frame speed controller 204 via transmission line 216 to transmit current status information or requested trick play speed inputted by the end user.

It should be noted that although the present disclosure describes a method for providing trick play control of streaming digital video in terms of rate of transmission of frames, the present method is equally adaptable to providing trick play control of streaming digital video in terms of rate of transmission of fields. In other words, those skilled in the art will realize that each picture of the video data can be expressed as a frame or a pair of fields. Furthermore, the present invention broadly covers providing trick play control of streaming digital video in terms of rate of transmission of data packets, e.g., representing rate of transmission of frames or fields as rate of transmission of data packets.

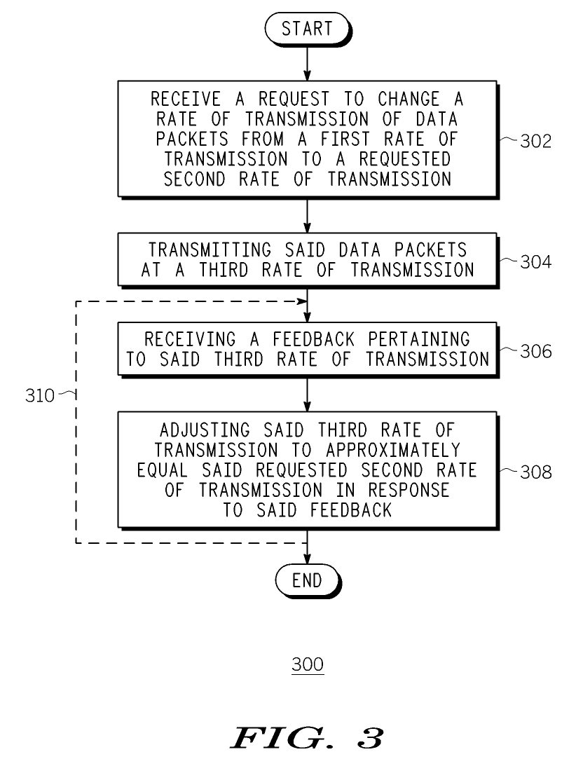

FIG. 3 illustrates an exemplary flow chart of a method 300 for providing adaptive trick play control of streaming digital video. Method 300 will be discussed in conjunction with FIG. 2 for clarity. Method 300 begins at step 302 where a request to change a rate of transmission of the data packets from a first rate of transmission to a requested second rate of transmission is received. In an exemplary embodiment, the request may be received from an end user of video player 104. For example, the video decoder 206 receives the end user's inputted request and transmits it to server frame speed controller 204 via, for example, transmission line 216. The requested second rate of transmission may be greater than the first rate of transmission by any factor for fast forward or fast rewind trick play of the data packets. For example, the requested second rate of transmission may be a request to increase the first rate of transmission by a factor of 2, 3, 4 or 5 and so on. In addition, the requested second rate of transmission may be less than the first rate of transmission for slow motion trick play of the data packets, thus reducing the first rate of transmission by a factor ½, ¼ or ⅛, and so on.

Once the request is received, the data packets are transmitted at a third rate of transmission in step 304. Typically, the data packets are transmitted at the third rate of transmission from the video feeder 202 of video server 102 to video decoder 206 of video player 104 via, for example, transmission line 212. In an exemplary embodiment, the server frame speed controller 204 attempts to initially control the third rate of transmission to be approximately equal to the requested second rate of transmission. As discussed above, due to un-deterministic delay, complexity in the encoding of the current video frames due to a large amount of motions or scene changes, buffering of packets, and the like, the delivery of frames to the user may not actually achieve the playback speed as requested by the user. As such, the third rate of transmission is approximately equal to the requested second rate of transmission during the initial stage of providing the trick play mode.

At step 306, a feedback pertaining to the third rate of transmission is received. In an exemplary embodiment, speed and position sensor 208 obtains information from the transmitted data packets. For example, each data packet may be a single frame of a requested streaming digital video. Some digital video contains indexed frames such as, for example, compressed video in MPEG format. Each indexed frame contains information such as, for example, time, position, type and length. In an exemplary embodiment, time is the time to play the frame in a normal play mode in milliseconds (ms). Position is the start position or offset in the MPEG file to retrieve the frame. Type is the frame type, such as I, P or B frame in MPEG2. Length is the number of bytes to represent the frame in the MPEG file starting at position. Speed and position sensor 208 may use this information, for example from two consecutive frames, to calculate a perceived rate of transmission. Speed and position sensor 208 transmits this information as part of the feedback to server frame speed controller 204 via, for example, transmission line 218.

At step 308, the third rate of transmission is adjusted to approximately equal said requested second rate of transmission in response to said feedback. The server frame speed controller 204 uses the feedback information to calculate the appropriate adjustment to the third rate of transmission. The calculations of server frame speed controller 204 are discussed in further detail below.

Consequently, the present invention provides an adaptive trick play control for streaming digital video that is smooth, accurate and consumes minimal bandwidth. For example, accuracy is achieved because the feedback from speed and position sensor 208 allows server frame speed controller 204 to ensure the third rate of transmission equals the requested second rate of transmission. In an exemplary embodiment, the third rate of transmission may be within an acceptable error tolerance of the requested second rate of transmission. In other words, if an end user requests that the streaming digital video play at two times the normal rate, the server frame speed controller 204 adjusts the third rate of transmission such that the streaming digital video will play in exactly half of the time of the normal rate within an error tolerance of w, for example, ten percent. Moreover, if an end user request that the streaming digital video play at four times the normal rate, the server frame speed controller 204 adjusts the third rate of transmission such that the streaming digital video will play in exactly one quarter of the time of the normal rate within an error tolerance of w, for example, ten percent, and so forth.

Method 300 provides an optional step 310. Optional step 310 repeats the receiving feedback step 306 and adjusting step 308 until the transmission of data packets ends or the end user requests the video player 104 to exit trick play. Method 300 provides the optional step 310 to help ensure that the third rate of transmission will continually match the requested second rate of transmission and not vary over time due to network congestion or other factors affecting the rate of transmission of the data packets. Furthermore, optional step 310 may be repeated after a predefined interval of data packets or frames are sent. For example, the predefined interval may be set to be every two frames or every two data packets and so on. The predefined interval may be any value, but preferably a smaller value. The smaller the value of the predefined interval, the sooner any unacceptable gaps between the third rate of transmission and the requested second rate of transmission, for example outside of the error tolerance, may be detected and, thereby, corrected by server frame speed controller 204 in step 308.

A further detailed illustration of an exemplary flow chart of data communications 400 between the video server 102 and video player 104 is illustrated in FIG. 4. Data communications 400 begins at step 402 when video player 104 sends a connection request and identity to video server 102. More specifically, video player 104 may request a particular video via video streaming. In the request, the video player 104 also provides its identity, e.g. user name, password, IP address, and the like.

At step 404, video server 102 sends a capability request to video player 104 if access is granted. In response to the capability request, the video player 104 sends a capability report back to video server 102 in step 406. The capability report informs the video server 102 what types of information the video player 104 may accept, such as for example, MPEG4 video, MPEG2 video, or audio only, such as for example, MP3. The capability report will provide the video server 102 with information to allow the server frame speed controller 204 to make proper calculations for any adjustments to the transmission rate that may be necessary when an end user requests trick play of a requested streaming digital video.

At step 408, the video server 102 instructs the video player 104 to set the player mode to normal play. Then at step 410, the data packets are transmitted at a rate for normal play. Step 410 may be repeated until the transmission of data packets are completed (i.e. the streaming digital video ends) or until step 412 occurs, where a request for trick play is sent from the video player 104 to the video server 102. As discussed above, a request for trick play is a request inputted by the end user to fast forward, fast rewind, or slow motion replay a requested streaming digital video.

At step 414, the video server 102 transmits an instruction to video player 104 to set the player mode to trick play. At step 416, the video player 104 transmits a status report to video server 102. The status report transmits information such as, for example, a position marker of the data currently being displayed, a time marker of the data packet currently being displayed and the decoder time of the data packet currently being displayed.

At step 418, the video server 102 instructs the video player 104 to clear any information currently stored in a buffer of video player 104. Subsequently, at step 420, the data packets are transmitted at a rate for trick play. Finally, at step 422, another player status report is sent from video player 104 to video server 102. The player status report transmitted at step 422 may include, for example, the feedback information as discussed above in step 306 of FIG. 3.

Similar to optional step 310 in FIG. 3, steps 424 and 426 may also be optional steps. In step 424, the data packets are transmitted at a rate for trick play that may have been adjusted in accordance with the feedback received in step 422. Thus, the rate of transmission in step 424 may be different than the rate of transmission at step 420 if the server frame speed controller 204 adjusts the transmission rate in response to the feedback contained in the status report transmitted in step 422. In step 426, the video player 104 may transmit another player status report similar to the status report transmitted at step 422. Steps 424 and 426 may be repeated until an end user requests the video player 104 to exit trick play mode or the transmission of data packets is completed.

FIG. 5 illustrates an exemplary data structure of a data packet 500 transmitted from the video server 102 to the video player 104. Data packet 500 may include commands 502, time stamp 504, size 506 and data 508. In an exemplary embodiment, the commands 502 of data packet 500 may comprise 8 bits and may include various instructions to be transmitted to the video player 104 as depicted in FIG. 5. In addition, the time stamp 504 comprises 64 bits and the size 506 comprises 16 bits. Although several illustrative commands are shown in FIG. 5, these commands should not be interpreted to limit the scope of the present invention, any number and type of commands can be communicated from the video server 102 to the video player 104.

FIG. 6 illustrates an exemplary data structure of data packet 600 that is transmitted from the video player 104 to the video server 102. Data packet 600 may include a message type 602 comprising 8 bits, a size 604 comprising 16 bits and a message payload 606. In an exemplary embodiment, message type 602 includes various messages to be transmitted to the video server 102 as depicted in FIG. 6. Again, although several illustrative messages are shown in FIG. 6, these messages should not be interpreted to limit the scope of the present invention. Any number and type of messages can be communicated from the video player 104 to the video server 102.

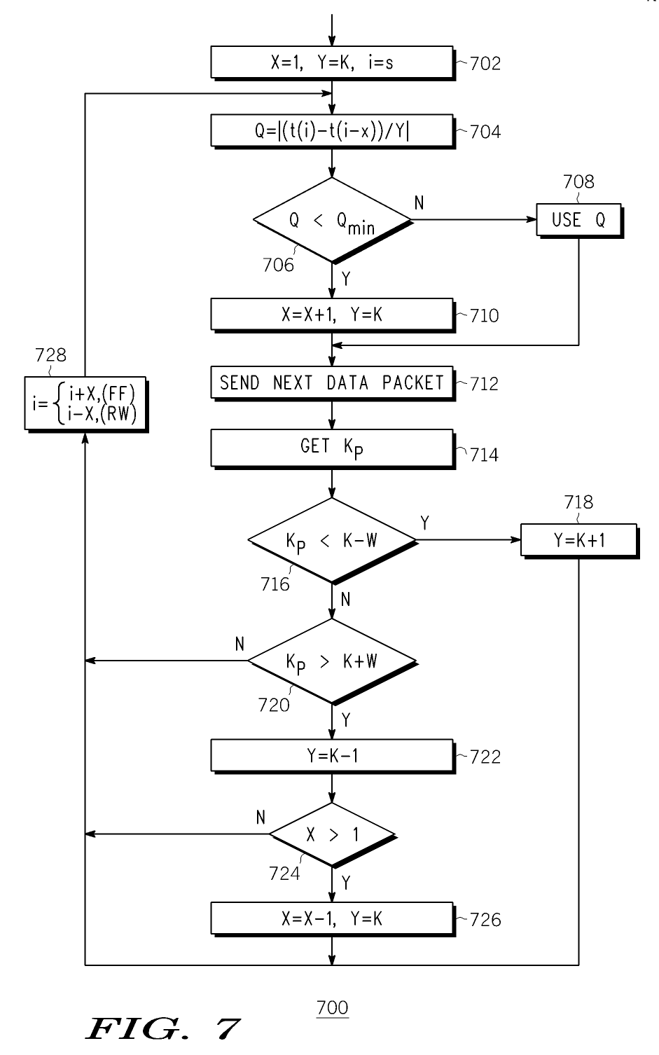

FIG. 7 illustrates a detailed flow chart of a method 700 for providing adaptive trick play control of streaming video executed by, for example, the server frame speed controller 204. Method 700 begins at step 702 by initializing parameters X, Y and i. Parameter X represents the number of frames to skip during play back of the data packets. In an exemplary embodiment, parameter X is initially set to equal 1 to maximize the smoothness of the trick play. In other words, the fewer frames that are skipped, the smoother the trick play of the streaming digital video will appear to the end user at video player 104.

In addition, in an exemplary embodiment of the present invention, the frames to be skipped are determined by server frame speed controller 204. Video decoder 206 simply plays what is provided by video feeder 202 as instructed by server frame speed controller 204. Server frame speed controller 204 may decide to skip frames by any method known in the art of trick play. For example, if the requested streaming digital video is in MPEG format, the server speed controller 204 may decide to play only I frames and skip B and P frames as necessary within the constrains of parameter X.

Parameter Y controls an interval between the frames that are displayed. Parameter Y may be considered to control the rate of transmission of the data packets, as discussed above. In an exemplary embodiment, parameter Y is initialized to K, e.g., setting K=1 as a default value for normal play. Value K represents the trick play speed requested by the end user at video player 104. In other words, K may be inputted by the end user. For example, if the end user requested fast forwarding a streaming digital video at a rate two times faster than the current playing speed, the value of K would equal 2, and Y would equal 2. Usually, if the method is beginning from a normal play mode, K may be initialized to a value of 1. Finally, parameter i represents the initial frame index s, where s is the starting frame index for trick play.

At step 704, a value of Q may be calculated according to equation (1) as illustrated below:

Q=ABS[(t(i)−t(i−X))/Y] (1)

Parameter Q represents the frame play interval in milliseconds (ms), or in other words, the amount of time between each transmitted frame. Parameter t(i) represents the value of time of an indexed MPEG video frame at initial frame index i, as discussed above. ABS represents the absolute value. For example, if X=1 (i.e. no frames are being skipped for smoother fast forward trick play), the video player 104 is in normal play mode so Y=K=1, consecutive frames are played, then Q=ABS [(t(i)−t(i−X)/1]. However, for example, if X=1 and an end user request fast forward trick play at a rate that is twice the normal play, then Y=K=2, consecutive frames are still played (i.e. t(1)−t(0)=1) and Q=ABS [(t(i)−t(i−X)/2]. In other words, to play streaming digital video in fast forward trick play mode at twice the rate of normal play, the frame play interval Q, must be reduced in half. Moreover, if an end user requests fast rewind trick play mode, parameter X would equal −1 because the frame previous to the current frame t(i) would be skipped.

At step 706, parameter Q is compared to parameter Qₘᵢₙ. Parameter Qₘᵢₙ represents the minimum decoding time for each frame. Parameter Qₘᵢₙ may vary depending on the capabilities of video player 104 or the format of the data packets being transmitted. This information may be transmitted from the video player 104 to video server 102, as discussed above, in step 406 of FIG. 4. In an exemplary embodiment, parameter Qₘᵢₙ may be calculated using equation (2) as illustrated below:

Qₘᵢₙ=1000/R ms (2)

Parameter R is the normal decoding rate of the data packets of a particular format. For example, R=30 frames per second for most TV quality MPEG 2 streams. In this case, Qₘᵢₙ=34 ms. In another example, if R=60, then Qₘᵢₙ=17 ms. The value of R is generally encoded in the data packets, such as for example, MPEG video streams.

Referring again to step 706, if Q<Qₘᵢₙ is false, then the method 700 proceeds to step 708 and uses frame play interval Q and proceeds to step 712. This is because the video player 104 is capable of decoding the data packets within the frame play interval Q. However if Q<Qₘᵢₙ (i.e. the frame play interval Q calculated is less than the smallest frame play interval that can be handled by video player 104 or the minimum frame play interval required by a specific format of the data packets) is true, then the method 700 proceeds to step 710 to increase X by 1. In other words, to increase the frame play interval Q to a value that can be handled by the video player 104, the number of frames to be skipped (i.e. parameter X) must be increased.

At step 712, the next data packet is transmitted. Subsequently, at step 714, a parameter Kₚ is transmitted from the video player 104 to the video server 102. Parameter Kₚ represents the perceived rate of transmission transmitted as part of the feedback information, as discussed above with reference to step 306 of FIG. 3. The perceived rate of transmission Kₚ may be calculated by speed and position sensor 208 and subsequently, transmitted to video server 102 as feedback. The perceived rate of transmission Kₚ may be calculated using equation (3) as follows:

Kₚ=ABS[(t(i)−t(j))/(d(i)−d(j))] (3)

Parameters t(i) and t(j) are the time value of an indexed frame, as discussed above, at time i and time j. Parameters d(i) and d(j) represent the real time for video player 104 to decode each frame at time i and j. If less than two data packets are received by video player 104, then Kₚ may be initialized to a default value of 1.

At step 716, Kₚ is compared to the requested trick play speed K less an error tolerance w. As previously discussed, the requested trick play speed K may be inputted by an end user at video player 104. If Kₚ is less than K−w (i.e. the perceived rate of transmission is slower than the requested rate of transmission) then Y is increased (i.e. to decrease the frame play interval Q, thereby, speeding up the perceived rate of transmission Kₚ to match the requested rate of transmission K) at step 718. Subsequently, the method 700 proceeds to step 728 and transmits the next frame or previous frame depending on whether the requested trick play is fast forwarding or fast rewinding.

However, if step 716 is false, then method 700 proceeds to step 720 to determine if Kₚ is greater than K+w (i.e. the perceived rate of transmission is faster than the requested rate of transmission). If Kₚ is not greater than K+w, then Kₚ is substantially equal to the requested rate of transmission K from the end user at video player 104 and no adjustment is necessary. Consequently, the method 700 proceeds to step 728 and transmits the next data packet accordingly.

On the other hand, if step 720 is true, then method 700 proceeds to step 722. At step 722, the value of Y is decreased (i.e. to increase the frame play interval Q, thereby, slowing down the perceived rate of transmission). Subsequently, the method 700 proceeds to step 724 to determine if X>1 (i.e. if every frame is being played or not). One of the goals of the present invention is to also provide smooth trick play. To achieve this, the value of X should remain 1 or as close to 1 as possible such that every frame is played. Consequently, in an exemplary embodiment, it is preferable to increase the frame play interval Q by playing more frames, then decreasing the value of Y if possible. Therefore, at step 724, if X>1 is true, the method 700 proceeds to step 726 to decrease the value of X and reset the value of Y to the requested rate of transmission K. Subsequently, the method 700 proceeds to step 728. However, if X>1 is false, the value of X cannot be reduced any further and the method 700 proceeds to step 728.

FIG. 8 illustrates a high level block diagram of an exemplary general purpose computer suitable for use in performing the functions described herein. As depicted in FIG. 8, the system 800 comprises a processor element 802 (e.g., a CPU), a memory 804, e.g., random access memory (RAM) and/or read only memory (ROM), a server frame speed controller module 805 for providing adaptive trick play control of streaming digital video, and various input/output devices 806 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the processes provided by the present server frame speed controller module 805 can be loaded into memory 804 and executed by processor 802 to implement the functions as discussed above. As such, the processes provided by the server frame speed controller module 805 (including associated data structures) of the present invention can be stored on a computer readable medium or carrier, e.g., RAM memory, magnetic or optical drive or diskette and the like.

While the foregoing is directed to illustrative embodiments of the present invention, other and further embodiments of the invention may be devised without departing from the basic scope thereof, and the scope thereof is determined by the claims that follow.

What is claimed is:

1. A method for providing adaptive trick play control of streaming digital video, comprising:
receiving a request to change a rate of transmission of frames or fields from a first rate of transmission to a requested second rate of transmission;
transmitting said frames or fields at a third rate of transmission;
receiving a feedback pertaining to said third rate of transmission; and
adjusting said third rate of transmission to approximately equal said requested second rate of transmission in response to said feedback.

2. The method of claim 1, wherein said first rate of transmission is a normal playback speed and said requested second rate of transmission is a requested trick play speed.

3. The method of claim 2, wherein said requested trick play speed comprises any factor of speed greater than said normal playback speed.

4. The method of claim 1, wherein said requested second rate of transmission is in either a forward direction or in a reverse direction.

5. The method of claim 1, wherein each one of the frames or fields is transported in one or more data packets.

6. The method of claim 1, wherein said adjusting step comprises at least one of: reducing a frame play interval, skipping the transmission of some of the frames or fields or simultaneously reducing the frame play interval and skipping the transmission of some of the frames or fields.

7. The method of claim 1, further comprising:
defining an interval comprising a number of transmitted frames or fields; and
receiving said feedback in accordance with said interval to continuously ensure said third rate of transmission is approximately equal to said requested second rate of transmission.

8. The method of claim 1, wherein said third rate of transmission is adjusted to approximately equal said requested second rate of transmission within an error tolerance range.

9. A system for providing adaptive trick play control of streaming digital video, comprising:
a server frame speed controller for receiving a request to change a rate of transmission of frames or fields from a first rate of transmission to a requested second rate of transmission, for receiving a feedback pertaining to a third rate of transmission, and for adjusting said third rate of transmission to approximately equal said requested second rate of transmission in response to said feedback; and
a video feeder, coupled to said server frame speed controller, for transmitting said frames or fields at said third rate of transmission.

10. The system of claim 9, wherein said first rate of transmission is a normal playback speed and said requested second rate of transmission is a requested trick play speed.

11. The system of claim 10, wherein said requested trick play speed comprises any factor of speed greater than said normal playback speed.

12. The system of claim 9, wherein said requested second rate of transmission is in either a forward direction or in a reverse direction.

13. The system of claim 9, wherein each one of the frames or fields is transported in one or more data packets.

14. The system of claim 9, wherein said server frame speed controller reduces a frame play interval, skips the transmission of some of the frames or fields, or both reduces the frame play interval and skips the transmission of some of the frames or fields.

15. The system of claim 9, further comprising:
a speed and position sensor for defining an interval comprising a number of transmitted frames or fields, wherein said server frame speed controller receives said feedback in accordance with said interval to continuously ensure said third rate of transmission is approximately equal to said requested second rate of transmission.

16. The system of claim 9, wherein said third rate of transmission is adjusted to approximately equal said requested second rate of transmission within an error tolerance range.

17. A computer-readable medium having stored thereon a plurality of instructions, the plurality of instructions including instructions which, when executed by a processor, cause the processor to perform the steps of a method for providing adaptive trick play control of streaming digital video, comprising:
receiving a request to change a rate of transmission of frames or fields from a first rate of transmission to a requested second rate of transmission;
transmitting said frames or fields at a third rate of transmission;
receiving a feedback pertaining to said third rate of transmission; and
adjusting said third rate of transmission to approximately equal said requested second rate of transmission in response to said feedback.

18. The computer readable medium of claim 17, wherein said adjusting step comprises at least one of: reducing a frame play interval, skipping the transmission of some of the frames or fields or simultaneously reducing the frame play interval and skipping the transmission of some of the frames or fields.

19. The computer readable medium of claim 17, further comprising:
defining an interval comprising a number of transmitted frames or fields; and
receiving said feedback in accordance with said interval to continuously ensure said third rate of transmission is approximately equal to said requested second rate of transmission.

20. The computer readable medium of claim 17, wherein said third rate of transmission is adjusted to approximately equal said requested second rate of transmission within an error tolerance range.
